(19) United States
(12) Patent Application Publication
(10) Pub. No.: US 2016/0013458 A1
(43) Pub. Date: Jan. 14, 2016

(54) FLEXIBLE SECONDARY BATTERY

(71) Applicant: SAMSUNG SDI CO., LTD., Yongin-si (KR)

(72) Inventors: Junwon Suh, Yongin-si (KR); Jeong-Doo Yi, Yongin-si (KR); Juhee Sohn, Yongin-si (KR); Hyunhwa Song, Yongin-si (KR)

(21) Appl. No.: 14/704,895

(22) Filed: May 5, 2015

(30) Foreign Application Priority Data
Jul. 14, 2014 (KR) 10-2014-0088452

(51) Int. Cl. H01M 2/02; H01M 4/66; H01M 2/06; H01M 2/04

(52) U.S. Cl. CPC H01M 2/0202; H01M 2/0404; H01M 2/0482; H01M 4/661; H01M 2/06; H01M 2220/30

(57) ABSTRACT

A flexible secondary battery includes an electrode assembly including a first electrode layer, a second electrode layer, and a separator that is disposed between the first electrode layer and the second electrode layer; a gasket that is flexible and surrounds an edge of the electrode assembly; a first sealing sheet that is attached to a first surface of the gasket; and a second sealing sheet that is attached to a second surface of the gasket opposite the first surface.

### CROSS-REFERENCE TO RELATED APPLICATION

This application claims priority to and the benefit of Korean Patent Application No. 10-2014-0088452, filed on Jul. 14, 2014, in the Korean Intellectual Property Office, the disclosure of which is incorporated herein by reference in its entirety.

### BACKGROUND

1. Field

Aspects of the present invention relate to a flexible secondary battery.

2. Description of the Related Art

As electronic technology has developed, the market for various mobile electronic devices such as smart phones, smart pads, e-book readers, flexible tablet computers, or wearable medical devices as well as mobile phones, game players, portable multimedia players (PMPs), or MPEG audio layer-3 (MP3) players has greatly grown.

As the market for mobile electronic devices has grown, the demand for batteries suitable for use with such mobile electronic devices has likewise increased. As the demand for flexible mobile electronic devices with improved utility, mobility, storage, and impact resistance has increased, the demand for flexible batteries to be used in the flexible mobile electronic devices has also increased.

### SUMMARY

One or more embodiments of the present invention include a flexible secondary battery which maintains its stability even after it is repeatedly bent.

Additional aspects will be set forth or will be apparent from the following description, or may be learned by practice of the presented embodiments.

According to one or more embodiments of the present invention, a flexible secondary battery includes: an electrode assembly that includes a first electrode layer, a second electrode layer, and a separator that is disposed between the first electrode layer and the second electrode layer; a gasket that is flexible and surrounds an edge of the electrode assembly; a first sealing sheet that is attached to a first surface of the gasket; and a second sealing sheet that is attached to a second surface of the gasket opposite the first surface.

The gasket may include a single material.

A thickness of the gasket may range from about 80% to about 120% of a thickness of the electrode assembly.

Each of the first sealing sheet and the second sealing sheet may include a first insulating layer, a metal layer, and a second insulating layer, wherein the first insulating layer contacts the gasket and a difference between a melting point of the first insulating layer and a melting point of the gasket is equal to or less than 50° C.

The gasket and the first insulating layer may include the same material.

The first electrode layer may include a first active material unit, the first active material unit including a first metal current collector coated with a first active material, and a first non-coated portion on which the first active material is not coated and to which a first electrode tab is attached, and the second electrode layer may include a second active material unit, the second active material unit being including a second metal current collector coated with a second active material, and a second non-coated portion on which the second active material is not coated and to which a second electrode tab is attached.

The first electrode tab and the second electrode tab may be positioned in a space between the gasket and the first sealing sheet or in a space between the gasket and the second sealing sheet.

Insulating films may be attached to outer surfaces of the first electrode tab and the second electrode tab that overlap the gasket.

The gasket may include a first lead electrode and a second lead electrode that pass through one side of the gasket.

The first lead electrode may be adhered to the first electrode tab and the second lead electrode may be adhered to the second electrode tab in an internal space of the gasket.

The electrode assembly may further include a fixing member that fixes one end portion of each of the first electrode layer, the separator, and the second electrode layer together.

Another end portion of each of the first electrode layer, the separator, and the second electrode layer may undergo a greater displacement than the one end portion of each of the first electrode layer, the separator, and the second electrode layer when the flexible secondary battery is bent.

The fixing member may be disposed between the first non-coated portion and the separator and between the separator and the second non-coated portion and may be an adhesive or an adhesive tape.

The flexible secondary battery may further include a protective layer on an outer surface of the electrode assembly, wherein a bending stiffness of the protective layer is greater than an average bending stiffness of the first electrode layer, the separator, and the second electrode layer.

### BRIEF DESCRIPTION OF THE DRAWINGS

These and/or other aspects will become apparent and more readily appreciated from the following description of the embodiments, taken in conjunction with the accompanying drawings in which:

FIG. 1 is an exploded perspective view illustrating a flexible secondary battery according to an embodiment of the present invention;

FIG. 2 is a plan view illustrating an electrode assembly of the flexible secondary battery of FIG. 1;

FIG. 3 is a cross-sectional view taken along the line I-I of FIG. 2;

FIG. 4 is an exploded perspective view illustrating a flexible secondary battery that is a modification of the flexible secondary battery of FIG. 1; and

FIG. 5 is a plan view illustrating a gasket of the flexible secondary battery of FIG. 4.

### DETAILED DESCRIPTION

The present invention may include various embodiments and modifications, and exemplary embodiments thereof will be illustrated in the drawings and will be described herein in detail. The effects and features of the present invention and the accompanying methods thereof will become apparent from the following description of the embodiments, taken in conjunction with the accompanying drawings. However, the present invention is not limited to the embodiments described below, and may be embodied in various modes.

Detailed reference will now be made to embodiments, examples of which are illustrated in the accompanying drawings. In the drawings, the same elements are denoted by the same reference numerals, and a repeated explanation thereof may not be given.

It will be understood that although the terms “first”, “second”, etc. may be used herein to describe various elements, these elements should not be limited by these terms. These elements are only used to distinguish one element from another.

Also, when a first element is described as being “coupled to” or “connected to” a second element, the first element may be directly “coupled to” or “connected to” the second element or indirectly “coupled to” or “connected to” the second element with one or more intervening elements interposed therebetween.

As used herein, the singular forms “a,” “an” and “the” are intended to include the plural forms as well, unless the context clearly indicates otherwise.

It will be further understood that the terms “comprises” and/or “comprising” used herein specify the presence of stated features or components, but do not preclude the presence or addition of one or more other features or components.

It will be understood that when an element is referred to as being “formed on,” another element, it can be directly or indirectly formed on the other element. That is, for example, intervening elements may be present.

Sizes of elements may be exaggerated for convenience of explanation. In other words, since sizes and thicknesses of elements in the drawings are arbitrarily illustrated for convenience of explanation, the following embodiments are not limited thereto.

As used herein, the term “and/or” includes any and all combinations of one or more of the associated listed items. Expressions such as “at least one of,” when preceding a list of elements, modify the entire list of elements and do not modify the individual elements of the list.

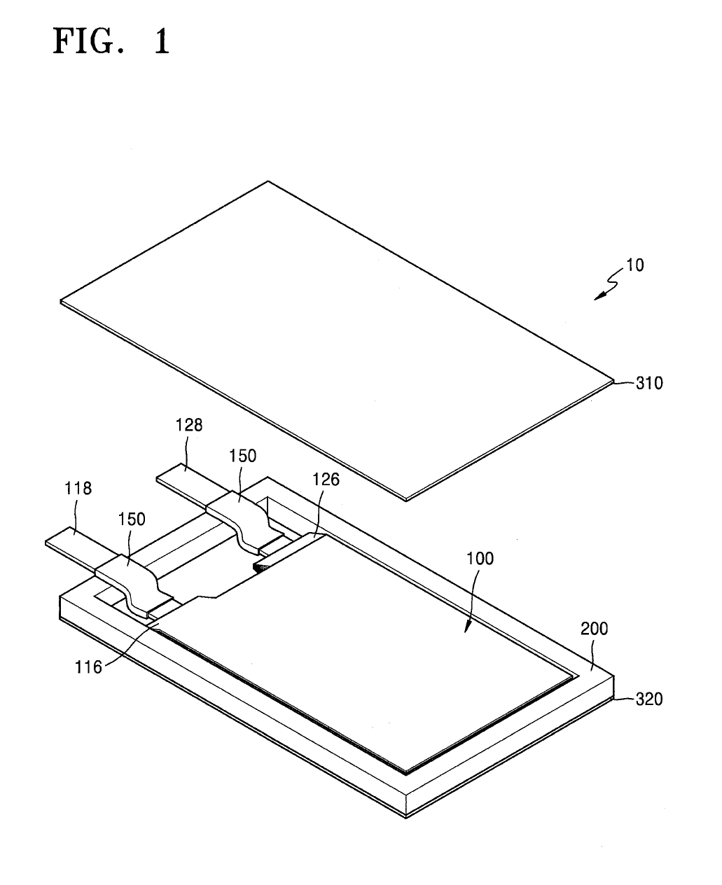

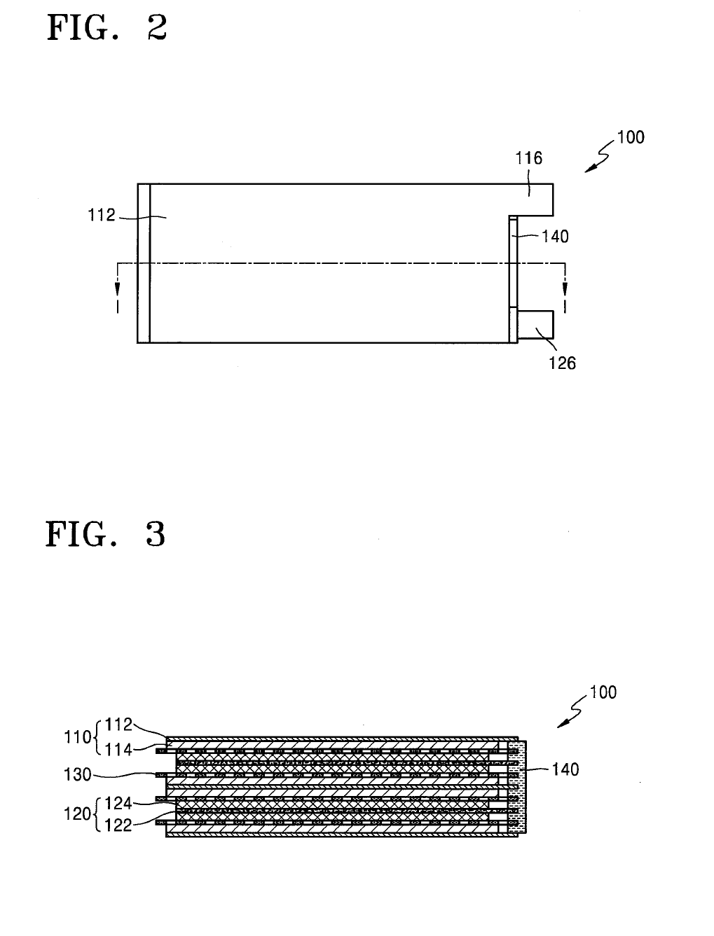

FIG. 1 is an exploded perspective view illustrating a flexible secondary battery 10 according to an embodiment of the present invention. FIG. 2 is a plan view illustrating an electrode assembly 100 of the flexible secondary battery 10 of FIG. 1. FIG. 3 is a cross-sectional view taken along the line I-I of FIG. 2.

Referring to FIGS. 1 through 3, the flexible secondary battery 10 according to one embodiment includes the electrode assembly 100, a gasket 200 that surrounds an edge of the electrode assembly 100, a first sealing sheet 310 that is attached to a first surface of the gasket 200, and a second sealing sheet 320 that is attached to a second surface of the gasket 200 opposite the first surface.

The electrode assembly 100 may include a first electrode layer 110, a second electrode layer 120, and a separator 130 that is disposed between the first electrode layer 110 and the second electrode layer 120. For example, the electrode assembly 100 may have a structure in which a plurality of the first electrode layers 110, a plurality of the separators 130, and a plurality of the second electrode layers 120 are repeatedly stacked.

The first electrode layer 110 may be a positive film or a negative film. When the first electrode layer 110 is a positive film, the second electrode layer 120 may be a negative film, and when the first electrode layer 110 is a negative film, the second electrode layer 120 may be a positive film.

The first electrode layer 110 may include a first metal current collector 112, a first active material unit 114 that is formed by coating a surface of the first metal current collector 112 with a first active material, and a first non-coated portion 116 on which the first active material is not coated. Similarly, the second electrode layer 120 may include a second metal current collector 122, a second active material unit 124 that is formed by coating a surface of the second metal current collector 122 with a second active material, and a second non-coated portion 126 on which the second active material is not coated.

When the first electrode layer 110 is a positive film, the first metal current collector 112 may be a positive current collector and the first active material unit 114 may be a positive active material unit. When the second electrode layer 120 is a negative film, the second metal current collector 122 may be a negative current collector and the second active material unit 124 may be a negative active material unit.

The positive current collector may be formed of aluminum, stainless steel, titanium, silver, or a combination thereof. The positive active material unit may include a positive active material, a binder, and a conductive material.

The positive active material may be a material that may reversibly occlude and release lithium ions. For example, the positive active material may include at least one selected from the group consisting of a lithium transition metal oxide such as lithium cobalt oxide, lithium nickel oxide, lithium nickel cobalt oxide, lithium nickel cobalt aluminum oxide, lithium nickel cobalt manganese oxide, lithium manganese oxide, or lithium iron phosphate, nickel sulfide, copper sulfide, sulfur, iron oxide, and vanadium oxide.

The binder may include at least one selected from the group consisting of a polyvinylidene fluoride-based binder such as polyvinylidene fluoride, vinylidene fluoride/hexafluoropropylene copolymer, or vinylidene fluoride/tetrafluoroethylene copolymer, a carboxymethyl cellulose-based binder such as sodium-carboxymethyl cellulose or lithium-carboxymethyl cellulose, an acrylate-based binder such as polyacrylic acid, lithium-polyacrylic acid, acryl, polyacrylonitrile, polymethyl methacrylate, or polybutyl acrylate, polyamideimide, polytetrafluoroethylene, polyethylene oxide, polypyrrole, lithium-nafion, and a styrene butadiene rubber-based polymer.

The conductive material may include at least one selected from the group consisting of a carbon-based conductive material such as carbon black, carbon fiber, or graphite, a conductive fiber such as a metal fiber, metal powder such as carbon fluoride powder, aluminum powder, or nickel powder, a conductive whisker such as zinc oxide or potassium titanate, a conductive metal oxide such as titanium oxide, and a conductive polymer such as a polyphenylene derivative.

The negative current collector may include at least one metal selected from the group consisting of copper, stainless steel, nickel, and titanium. The negative active material unit may include a negative active material, a binder, and a conductive material.

The negative active material may include a material that may form an alloy with lithium, or may reversibly occlude or release lithium. For example, the negative active material may include at least one selected from the group consisting of a metal, a carbon-based material, a metal oxide, and a lithium metal nitride.

The metal may include at least one selected from the group consisting of lithium, silicon, magnesium, calcium, aluminum, germanium, tin, lead, arsenic, antimony, bismuth, silver, gold, zinc, cadmium, mercury, copper, iron, nickel, cobalt, and indium.

The carbon-based material may include at least one selected from the group consisting of graphite, graphite carbon fiber, coke, mesocarbon microbeads (MCMB), polyacene, pitch-based carbon fiber, and hard carbon.

The metal oxide may include at least one selected from the group consisting of lithium titanium oxide, titanium oxide, molybdenum oxide, niobium oxide, iron oxide, tungsten oxide, tin oxide, amorphous tin mixed oxide, silicon monoxide, cobalt oxide, and nickel oxide.

The binder and the conductive material may be the same or substantially the same as those included in the positive active material unit.

The separator 130 may be formed by, but is not limited to, coating at least one material selected from the group consisting of polyethylene (PE), polystyrene (PS), polypropylene (PP), and a co-polymer of PE and PP with polyvinylidene fluoride cohexafluoropropylene (PVDF-HFP) co-polymer.

A first electrode tab 118 and a second electrode tab 128 are attached to the electrode assembly 110. In detail, the first electrode tab 118 and the second electrode tab 128 may be respectively attached by using welding or the like to a plurality of the first non-coated portions 116 and a plurality of the second non-coated portions 126 that are stacked.

The electrode assembly 100 may further include a fixing member 140 that fixes one end portion of each of the first electrode layer 110, the separator 130, and the second electrode layer 120. The fixing member 140 that is disposed between the first non-coated portion 116 and the separator 130 and between the separator 130 and the second non-coated portion 126 may be, but is not limited to, an adhesive or an adhesive tape.

The fixing member 140 fixes only the one end portion of each of the first electrode layer 110, the separator 130, and the second electrode layer 120. Accordingly, in an area where the fixing member 140 is not formed, the electrode assembly 100 may bend due to slippage between the first electrode 110, the separator 130, and the second electrode layer 120, and relative positions of the first electrode layer 110, the separator 130, and the second electrode layer 120 may be maintained due to the fixing member 140 even when the electrode assembly 100 is repeatedly bent.

The fixing member 140 may be formed on the same side of the electrode assembly 100 as the first electrode tab 118 and the second electrode tab 128 in a longitudinal direction of the electrode assembly 100.

When the electrode assembly 100 is bent, the other end portion of each of the first electrode 110, the separator 130, and the second electrode layer 120 on which the fixing member 140 is not formed undergoes a greater displacement than the one end portion of each of the first electrode layer 110, the separator 130, and the second electrode layer 120 on which the fixing member 140 is formed. Since the first electrode tab 118 may be adhered to the plurality of first non-coated portions 116 and the second electrode tab 128 may be adhered to the plurality of second non-coated portions 126, the first electrode tab 118 and the second electrode tab 128 may be actually used as fixing units, respectively, for fixing the first electrode layers 110 and the second electrode layers 120.

Accordingly, assuming that the fixing member 140 is formed on the opposite side of the electrode assembly 110 than the first electrode tab 118 and the second electrode tab 128 in the longitudinal direction of the electrode assembly 100, when the electrode assembly 100 is bent, the first electrode layer 110 and/or the second electrode layer 120 may bend between the first and second electrode tabs 118 and 128 and the fixing member 140 and a part of the fixing member 140 may be destroyed, thereby making it difficult to maintain an alignment of the first electrode layer 110, the separator 130, and the second electrode layer 120.

A protective layer (not shown) may be formed on an outermost surface of the electrode assembly 100. The protective layer may prevent or substantially prevent the first electrode layer 110, the separator 130, or the second electrode layer 120 from wrinkling when the electrode assembly 100 is bent. That is, when the electrode assembly 100 is bent, the first electrode layer 110, the separator 130, and the second electrode layer 120 tend to wrinkle in order to reduce compressive stress. When the first electrode layer 110, the separator 130, or the second electrode layer 120 is about to undergo a deformation with a small radius of curvature, such as a wrinkle, the protective layer may prevent or substantially prevent a greater deformation by pressing down the first electrode layer 110, the separator 130, or the second electrode 120 and may reduce stress applied to the first electrode 110, the separator 130, or the second electrode layer 120.

As such, in order for the protective layer to prevent or substantially prevent the first electrode layer 110, the separator 130, or the second electrode layer 120 from wrinkling, a bending stiffness of the protective layer may be greater than an average bending stiffness of the first electrode layer 110, the separator 130, and the second electrode layer 120. For example, the bending stiffness of the protective layer may be about 1.5 times greater than an average bending stiffness of the first electrode layer 110, the separator 130, and the second electrode layer 120.

Also, the protective layer may be formed of a material that is not only stiff (e.g., has a predetermined stiffness) but is also flexible (e.g., has a predetermined flexibility) in order not to affect the bending of the electrode assembly 100. For example, the protective layer may be formed as, but is not limited to, a polymer film, a film including a laminated polymer film layer, a metal foil, or a composite film including carbon. For example, the protective layer may have a thickness ranging from about 15 micrometers to about 1 millimeter, and a tensile modulus of elasticity of the protective layer may range from about 0.5 GPa to about 300 GPa.

The gasket 200 may surround the edge of the electrode assembly 100, and the first sealing sheet 310 may be attached to the first surface of the gasket 200, and the second sealing sheet 320 may be attached to the second surface of the gasket 200 that is opposite to the first surface. The first sealing sheet 310 and the second sealing sheet 320 may seal the electrode assembly 100 with the help of the gasket 200.

The gasket 200 may have an internal space whose central portion is open and in which the electrode assembly 100 may be located. The gasket 200 may be flexible. When the flexible 200 is flexible, the gasket 200 may bend along with the electrode assembly 100 when the electrode assembly 100 bends, and thus may distribute stress that may concentrate on the electrode assembly 100 when the flexible secondary battery 10 is bent, thereby preventing or substantially preventing damage to the electrode assembly 100. Also, the gasket 200 may be formed of a single flexible material. Accordingly, the gasket 200 may not have portions having different moduli of elasticity, thereby more effectively distributing stress during bending.

The first sealing sheet 310 and the second sealing sheet 320 may each include a first insulating layer, a metal layer, and a second insulating layer that are sequentially stacked. Each of the first insulating layer and the second insulating layer may be formed of PP, polyethyleneterephthalate (PET), or nylon, and the metal layer may be formed of, but is not limited to, aluminum, steel, or stainless steel.

For example, the first sealing sheet 310 and the second sealing sheet 320 may each have a three-layer structure including the first insulating layer formed of PP, the metal layer formed of aluminum, and the second insulating layer formed of PET, wherein the first insulating layer of each of the first sealing sheet 310 and the second sealing sheet 320 is disposed to contact the gasket 200.

The first insulating layer may be attached by using thermal bonding to the gasket 200. In this case, in order to improve a thermal bonding efficiency and increase a bonding force between the first insulating layer and the gasket 200, a difference between a melting point of a material of the gasket 200 and a melting point of a material of the first insulating layer is equal to or less than 50° C. For example, the gasket 200 and the first insulating layer may be formed of the same material.

The gasket 200 may be formed to have a thickness ranging from about 80% to about 120% of a thickness of the electrode assembly 100, thereby preventing or substantially preventing a bent portion from being formed in the first sealing sheet 310 and the second sealing sheet 320.

If the bent portion is formed in the first sealing sheet 310 and the second sealing sheet 320, stress may concentrate at the bent portion that is formed in the first sealing sheet 310 and the second sealing sheet 320 when the flexible secondary battery 10 bends, thereby resulting in damage (e.g., a tear) to the first sealing sheet 310 and the second sealing sheet 320.

However, according to the present embodiment, since the gasket 200 is formed to have a thickness ranging from about 80% to about 120% of that of the electrode assembly 100, stress may be uniformly distributed without concentrating on a specific portion of the first sealing sheet 310 and the second sealing sheet 320 when the flexible secondary battery 10 is bent, thereby improving the stability of the flexible secondary battery 10.

A method of manufacturing the flexible secondary battery 10 will now be briefly explained.

First, the second sealing sheet 320 is attached to the second surface of the gasket 200. The second sealing sheet 320 may be attached to the second surface of the gasket 200 such that the first insulating layer faces the gasket 200 and then the gasket 200 and the first insulating layer are thermally bonded to each other.

Next, the electrode assembly 100 is disposed in the internal space of the gasket 200, and then the first sealing sheet 310 is attached to the first surface of the gasket 200. A method of attaching the first sealing sheet 310 is the same or substantially the same as a method of attaching the second sealing sheet 320.

The first electrode tab 118 and the second electrode tab 128 of the electrode assembly 100 may be pulled to the outside through a space between the gasket 200 and the first sealing sheet 310. Also, in order to increase a bonding force between the gasket 200 and the second sealing sheet 310 and to prevent or substantially prevent a short-circuit between the first electrode tab 118 and the second electrode tab 128, insulating films 150 may be attached to outer surfaces of the first electrode tab 118 and the second electrode tab 128 that overlap the gasket 200.

Although the second sealing sheet 320 is first attached to the gasket 200 and then the first sealing sheet 310 is attached, the present embodiment is not limited thereto and the first sealing sheet 310 may be first attached, or the electrode assembly 100 may be disposed in the gasket 200 and then the first sealing sheet 310 and the second sealing sheet 320 may be concurrently (e.g., simultaneously) or sequentially attached to the gasket 200.

As such, in the present embodiment, since the gasket 200 provides a space in the flexible secondary battery 10 in which the electrode assembly 100 is received, a drawing process for forming a space to receive the electrode assembly 100, such as by creating a pouch as is used in the conventional art, may be omitted.

In the conventional art, as a thickness of the electrode assembly 100 increases, a drawing process increases in depth to correspond to the thickness of the electrode assembly 100, thereby increasing the risk of a crack in the pouch. In the flexible secondary battery 10 of the present embodiment, however, since a thickness of the gasket 200 is freely determined according to the thickness of the electrode assembly 100, a flexible secondary battery 10 having a large capacity may be easily manufactured.

In addition, since the gasket 200 is formed of a flexible material and bends along with the electrode assembly 100, stress that is generated when the flexible secondary battery 10 is bent may be uniformly distributed, thereby maintaining the stability and reliability of the flexible secondary battery 10.

Table 1 shows results obtained after the flexible secondary battery 10 including the gasket 200 according to an Embodiment and a flexible secondary battery not including the gasket 200 according to a Comparative Example are repeatedly bent 1000 times and 2000 times to a radius of curvature of 25 mm. Then, capacity retention rates of the flexible secondary battery 10 of the Embodiment and the flexible secondary battery of the Comparative Example are compared with each other. The Comparative Example corresponds to a case where a receiving portion in which the electrode assembly 100 may be received is formed in a pouch by using a drawing process and then the pouch is sealed using thermal bonding.

TABLE 1

| | Bending Cycles | | |
|---|---|---|---|
| | 0 | 1000 | 2000 |
| Comparative | 100% | 75.4% | 23.6% |
| Example | | | |
| Embodiment | 100% | 95.6% | 90.3% |

As shown in Table 1, in the Comparative Example, a capacity retention rate after 1000 bending cycles is reduced to 75.4% and is greatly reduced to 23.6% after 2000 bending cycles. In contrast, in the Embodiment, a capacity retention rate is equal to or greater than 90% even after 2000 bending cycles. This is because the gasket 200 bends along with the flexible secondary battery 10 when the flexible secondary battery 10 is bent and thus stress may be uniformly distributed, thereby preventing or substantially preventing damage to the electrode assembly 100.

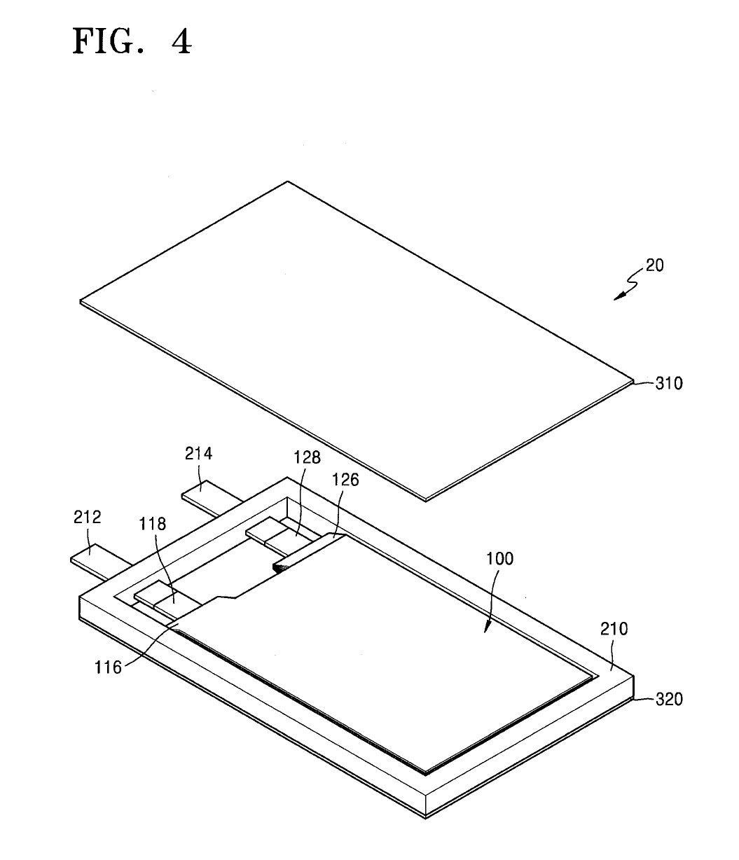

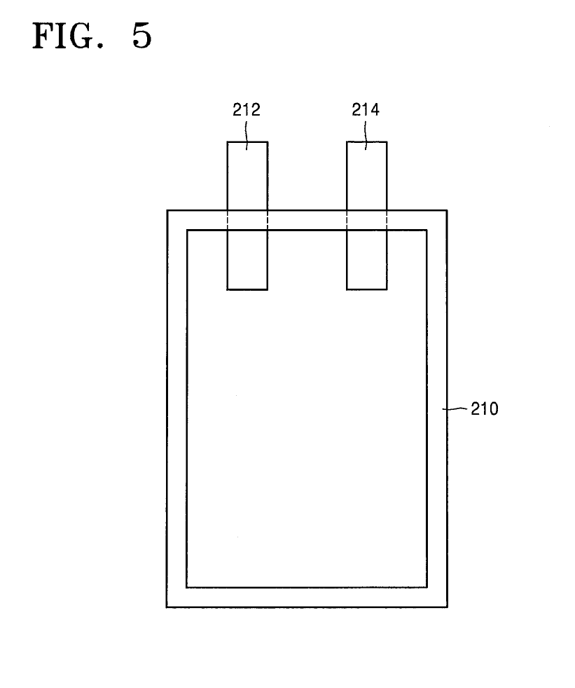

FIG. 4 is an exploded perspective view illustrating a flexible secondary battery 20 that is a modification of the flexible secondary battery 10 of FIG. 1. FIG. 5 is a plan view illustrating a gasket 210 of the flexible secondary battery 20 of FIG. 4.

Referring to FIGS. 4 and 5, the flexible secondary battery 20 may include the electrode assembly 100, the gasket 210 that surrounds an edge of the electrode assembly 100, the first sealing sheet 310 that is attached to a first surface of the gasket 210, and the second sealing sheet 320 that is attached to a second surface of the gasket 210 opposite the first surface.

The electrode assembly 100, the first sealing sheet 310, and the second sealing sheet 320 are the same or substantially the same as those of FIGS. 1 through 3, and thus, repeated explanations thereof will not be given.

The gasket 210 may surround the edge of the electrode assembly 100 and be formed of a flexible material. Accordingly, the gasket 210 bends along with the electrode assembly 100 when the flexible secondary battery 20 is bent, and thus may uniformly distribute stress, thereby effectively preventing or substantially preventing damage to the electrode assembly 100.

The gasket 210 may include a first lead electrode 212 and a second lead electrode 214 that pass through one side of the gasket 210. The first lead electrode 212 and the second lead electrode 214 may be integrally formed with the gasket 210 by using insert molding.

The first lead electrode 212 may be adhered to the first electrode tab 118 in an internal space of the gasket 210, and the second lead electrode 214 may be adhered to the second electrode tab 128 in the internal space of the gasket 210. The first electrode tab 118 may be adhered to the first non-coated portion 116 and the second electrode tab 128 may be adhered to the second non-coated portion 126.

As such, when the first electrode tab 118 and the second electrode tab 128 are respectively connected to the first lead electrode 212 and the second lead electrode 214, the first electrode tab 118 and the second electrode tab 128 are connected to the outside without bending, thereby preventing or substantially preventing damage to the first electrode tab 118 and the second electrode tab 128. Also, since the first electrode tab 118 and the second electrode tab 128 are not disposed between the gasket 210 and the first sealing sheet 310 or the second sealing sheet 320, a bonding force between the gasket 210 and the first sealing sheet 310 or the second sealing sheet 320 may be increased.

A method of manufacturing the flexible secondary battery 20 is quite the same as the method of manufacturing the flexible secondary battery 10 described with reference to FIGS. 1 through 3. However, when the electrode assembly 100 is disposed in the internal space of the gasket 210, the first electrode tab 118 and the second electrode tab 128 may be respectively attached to the first lead electrode 212 and the second lead electrode 214 by using welding or the like.

As described above, according to the one or more of the above embodiments of the present invention, the stability and reliability of a flexible secondary battery may be maintained even after the flexible secondary battery is repeatedly bent.

Other unmentioned effects of the present invention will be apparent to one of ordinary skill in the art from the above description.

While the present invention has been particularly shown and described with reference to exemplary embodiments thereof using specific terms, the embodiments and terms have been used to explain the present invention and should not be construed as limiting the scope of the present invention as defined by the claims and their respective equivalents. Accordingly, it will be understood by those of ordinary skill in the art that various changes in form and details may be made therein without departing from the spirit and scope of the present invention as defined by the following claims and their respective equivalents.

What is claimed is:

1. A flexible secondary battery comprising:
an electrode assembly comprising a first electrode layer, a second electrode layer, and a separator between the first electrode layer and the second electrode layer;
a gasket that is flexible and surrounds an edge of the electrode assembly;
a first sealing sheet attached to a first surface of the gasket; and
a second sealing sheet attached to a second surface of the gasket opposite the first surface.

2. The flexible secondary battery of claim 1, wherein the gasket comprises a single material.

3. The flexible secondary battery of claim 1, wherein a thickness of the gasket is between about 80% to about 120% of a thickness of the electrode assembly.

4. The flexible secondary battery of claim 1, wherein each of the first sealing sheet and the second sealing sheet comprises a first insulating layer, a metal layer, and a second insulating layer,
wherein the first insulating layer contacts the gasket and a difference between a melting point of the first insulating layer and a melting point of the gasket is equal to or less than 50° C.

5. The flexible secondary battery of claim 4, wherein the gasket and the first insulating layer comprise the same or substantially the same material.

6. The flexible secondary battery of claim 1, wherein the first electrode layer comprises a first active material unit, the first active material unit comprising a first metal current collector coated with a first active material, and a first non-coated portion on which the first active material is not coated and to which a first electrode tab is attached, and
the second electrode layer comprises a second active material unit, the second active material unit comprising a second metal current collector coated with a second active material, and a second non-coated portion on which the second active material is not coated and to which a second electrode tab is attached.

7. The flexible secondary battery of claim 6, wherein the first electrode tab and the second electrode tab extends to the outside through a space between the gasket and the first sealing sheet or through a space between the gasket and the second sealing sheet.

8. The flexible secondary battery of claim 7, wherein insulating films are attached to outer surfaces of the first electrode tab and the second electrode tab that overlap the gasket.

9. The flexible secondary battery of claim 6, wherein the gasket comprises a first lead electrode and a second lead electrode that pass through one side of the gasket.

10. The flexible secondary battery of claim 9, wherein the first lead electrode is adhered to the first electrode tab and the second lead electrode is adhered to the second electrode tab in an internal space of the gasket.

11. The flexible secondary battery of claim 1, wherein the electrode assembly further comprises a fixing member that fixes one end portion of each of the first electrode layer, the separator, and the second electrode layer together.

12. The flexible secondary battery of claim 11, wherein another end portion of each of the first electrode layer, the separator, and the second electrode layer undergoes a greater displacement than the one end portion of each of the first electrode layer, the separator, and the second electrode layer when the flexible secondary battery is bent.

13. The flexible secondary battery of claim 6, wherein a fixing member is between the first non-coated portion and the separator and between the separator and the second non-coated portion and the fixing member is an adhesive or an adhesive tape.

14. The flexible secondary battery of claim 1, further comprising a protective layer on an outer surface of the electrode assembly,
wherein a bending stiffness of the protective layer is greater than an average bending stiffness of the first electrode layer, the separator, and the second electrode layer.
